(19) United States
(12) Patent Application Publication
(10) Pub. No.: US 2004/0266349 A1
(43) Pub. Date: Dec. 30, 2004

(54) Telephone-controlling device for intergrating bluetooth communication

(76) Inventor: Charlene Wang, Taipei (TW)

Correspondence Address: Han-Yi Lee, BAYSHORE PATENT GROUP, LLC., 520 Chantecler Dr., Fremont, CA, 94539, US

(21) Appl. No.: 10/680,638

(22) Filed: Oct. 7, 2003

(30) Foreign Application Priority Data
Jun. 30, 2003 (TW) 092211895

(51) Int. Cl. H04B 7/15; H04M 9/00; H04M 1/00

(52) U.S. Cl. 455/41.2; 455/569.1; 455/575.2; 455/11.1; 379/448; 379/428.02; 379/430

(57) ABSTRACT

The telephone-controlling device for integrating bluetooth communication comprises: a microprocessor, a telephone interface circuit and a bluetooth interface circuit. The microprocessor controls the telephone interface circuit and the bluetooth interface circuit and renders the telephone interface circuit to connect with an external telephone network, also renders the bluetooth interface circuit to connect with a bluetooth headset. The telephone interface circuit connects with the microprocessor to connect the external telephone network and the bluetooth interface circuit connects with the microprocessor to proceed with wireless two-way transmission of sound messages with the bluetooth headset; hence when in receiving a phone call through the external telephone network, the microprocessor proceeds to control in order that the bluetooth headset communicates with the telephone directly.

### FIELD OF THE INVENTION

The present invention is related to a controlling device for telephone transferring, and especially to a telephone-controlling device for integrating bluetooth communication.

### BACKGROUND OF THE INVENTION

Conventional wireless telephone sets proceed with wireless transmission of voice mainly by using wireless telephone receivers. Users hold receivers to move freely in certain distances, and talk over by telephone at the same time. However, the volume of a wireless telephone receiver is often too large, it is not suitable for a user to carry it on his person. When a phone call is coming, a user still have to go to the site where the receiver is to pick it up; this is less convenient in application.

Conventional hands-free kits for mobile phones are mainly applied to mobile phones. For instance, a bluetooth headset as a hands-free kit for a mobile phone is an obvious application example. However, the hands-free kit of the bluetooth headset can't get in communication with a traditional telephone directly, a user of the traditional telephone cannot obtain the convenience brought by the bluetooth headset.

Therefore, in view of the defects of conventional techniques, the inventor of the present invention studied to improve and to combine the bluetooth technology to render users able to take the bluetooth headsets as the abovementioned hands-free kits for use and for proceeding with telephone vocal message transmission with a Public Switch Telephone Network (PSTN) connecting with traditional telephone sets.

### SUMMARY OF THE INVENTION

The primary object of the present invention is to provide a telephone-controlling device for connecting with a Public Switch Telephone Network (PSTN) to render the transferring function of the telephone-controlling device to make a bluetooth headset as a hands-free kit for use.

To obtain the abovementioned object, the present invention provides a telephone-controlling device for integrating bluetooth communication, the device comprises: a microprocessor, a telephone interface circuit and a bluetooth interface circuit; the microprocessor controls the telephone interface circuit and the bluetooth interface circuit, thereby it renders the telephone interface circuit to connect with an external telephone network, and renders the bluetooth interface circuit to connect with a bluetooth headset; the telephone interface circuit connects with the microprocessor to connect the external telephone network; the bluetooth interface circuit connects with the microprocessor to proceed with wireless two-way transmission of sound messages with the bluetooth headset; therefore, when in receiving a phone call through the external telephone network, the microprocessor proceeds to control in order that the bluetooth headset can make communication with the telephone directly.

The present invention will be apparent in its object, features and functions after reading the detailed description of the preferred embodiment thereof in reference to the accompanying drawings.

### BRIEF DESCRIPTION OF THE DRAWINGS

FIG. 1 is a circuit diagram showing the telephone-controlling device for integrating bluetooth communication of the present invention;

FIG. 2 is a control flowchart showing how a microprocessor controls a telephone interface circuit and a bluetooth interface circuit; and

FIG. 3 is a flowchart showing controlling of turning on a small night-light.

### DETAILED DESCRIPTION OF THE INVENTION

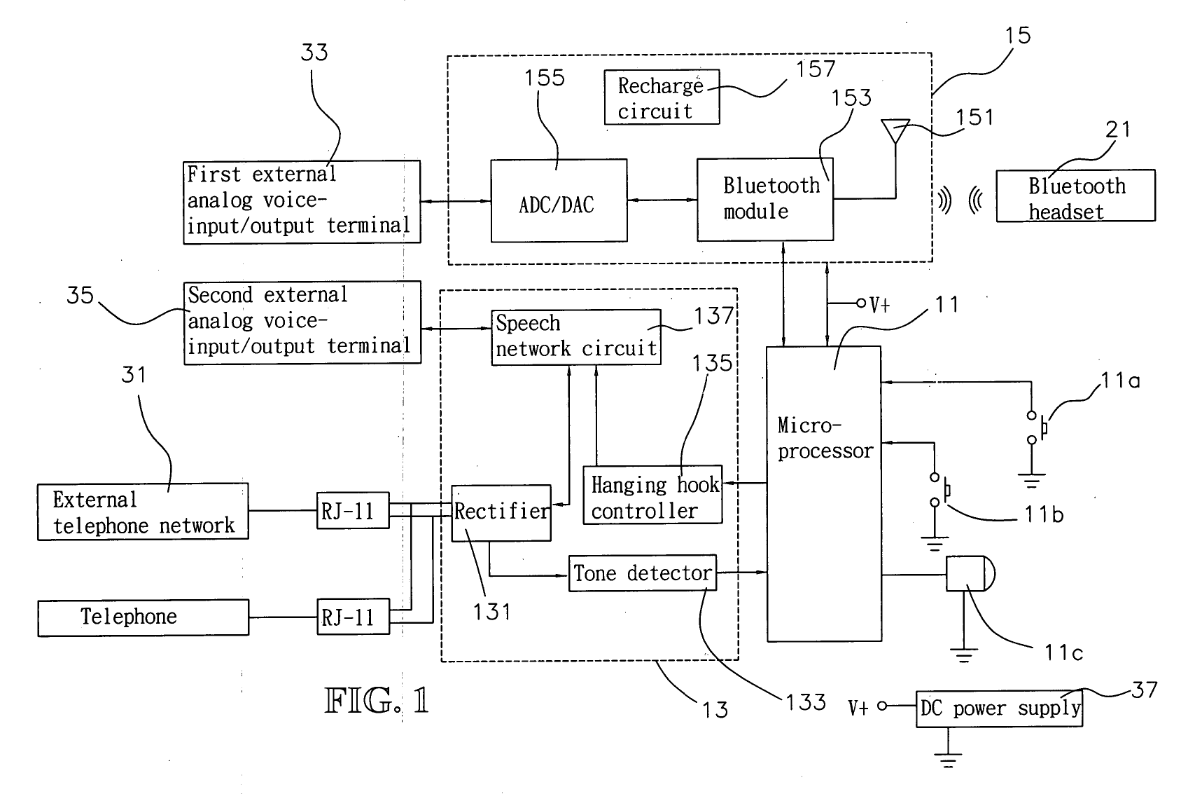

FIG. 1 depicts a circuit diagram showing the telephone-controlling device for integrating bluetooth communication of the present invention. The telephone-controlling device for integrating bluetooth communication of the present invention comprises primarily: a microprocessor 11, a telephone interface circuit 13 and a bluetooth interface circuit 15. The microprocessor 11 is used to control a telephone interface circuit 13 and a bluetooth interface circuit 15 to render the telephone interface circuit 13 to connect with an external telephone network 31 and to render the bluetooth interface circuit 15 to connect with the bluetooth headset 21. The telephone interface circuit 13 is mainly to connect with the external telephone network 31, for example, the Public Switch Telephone Network (PSTN) is a kind of the external telephone network 31. The telephone interface circuit 13 simultaneously transmits signals coming from the external telephone network 31 to the microprocessor 11, and transmits signals coming from the bluetooth interface circuit 15 to the external telephone network 31. The telephone interface 13 is controlled by the microprocessor 11. The bluetooth interface circuit 15 is mainly to proceed with wireless two-way transmission of sound messages with the bluetooth headset 21. On the one hand, the telephone vocal messages coming from the external telephone network 31 can be transmitted to the bluetooth headset 21 by way of the transmission path from the telephone interface 13 to the bluetooth interface circuit 15; on the other hand, the vocal messages coming from the bluetooth headset 21 can be transmitted to the external telephone network 31 by way of the transmission path from the bluetooth interface circuit 15 to the telephone interface headset 13. A DC power supply 37 is used mainly to provide electricity for the telephone-controlling device in integrating bluetooth communication of the present invention; the DC power supply 37 can be a power supply from a DC adapter.

The structure of the telephone interface circuit 13 includes primarily: a rectifier 131 connecting with a telephone line, the telephone line is connected with the external telephone network 31. Generally speaking, in the mode of connecting with the telephone line, an RJ-11 connector is adopted mainly to connect with the external telephone network 31. A tone detector 133 connects with the rectifier 131, the major function of the tone detector 133 is to output telephone ringing signals for the microprocessor 11 to detect whether the phone call rings, and to judge coming/not coming of a phone call. A hanging hook controller 135 is provided with a major function of making the microprocessor 11 control on/off hook in order to hang up or put through the phone call of the external telephone network 31; as to the specific circuit means of the hanging hook controller 135, the present invention can adopt an electronic hanging-hook controller or a mechanical hanging-hook controller controlled by signals. A speech network circuit 137 is provided to connect respectively with the hanging hook controller 135, the rectifier 131, and a second external analog voice-input/output terminal 35; the speech network circuit 137 is used mainly in receiving vocal messages from the external telephone network 31, and transmitting vocal messages to the external telephone network 31. The sound messages from the telephone of the other side coming through the external telephone network 31 are picked up by the speech network circuit 137, and are transferred to the second external analog voice-input/output terminal 35. The present invention can render a first external analog voice-input/output terminal 33 to electrically connect with the second external analog voice-input/output terminal 35 in order to transmit the telephone sound messages of the other side to the bluetooth headset 21; meanwhile, the sound messages coming from the bluetooth headset 21 can be transmitted to the first external analog voice-input/output terminal 33. The abovementioned first external analog voice-input/output terminal 33 and the abovementioned second external analog voice-input/output terminal 35 are electrically connect with each other, in order that the sound messages of the bluetooth headset 21 can be transmitted to the other side via the speech network circuit 137 and the external telephone network 31.

The bluetooth interface circuit 15 is composed primarily of: an antenna 151 connecting with a bluetooth module 153. The bluetooth module 153 connects with the microprocessor 11, the major function of the bluetooth module 153 is to proceed with wireless two-way transmission of sound messages with the bluetooth headset 21; and by way of the abovementioned transmission paths, the bluetooth headset 21 proceeds with two-way telephone conversation with the external telephone network 31.

The bluetooth interface circuit 15 includes further a ADC/DAC (Analog-to-Digital Converter and Digital-to-Analog Converter) 155 for connecting with the bluetooth module 153, so as to convert the voice that transmitted between the bluetooth module 153 and the first external analog voice-input/output terminal 33; thereby the present invention can make use of the first external analog voice-input/output terminal 33 to proceed with vocal-message or other sound-message transmission with the bluetooth headset 21. The ADC/DAC 155 can make use of the Digital-to-Analog Converter (DAC) and Analog-to-Digital Converter (ADC) as specific implementation components.

As stated above, the first external analog voice-input/output terminal 33 of the present invention can be used to electrically connect with the second external analog voice-input/output terminal 35 in order to provide a voice transmission path between the bluetooth headset 21 and the phone call coming from the external telephone network 31. Moreover, the first external analog voice-input/output terminal 33 of the present invention can be used to connect with a personal computer, such as to connect with an input/output end of a sound card of the personal computer, so that the bluetooth headset 21 can proceed with two-way vocal message (or some other sound message) transmission with the personal computer. Further, the first external analog voice-input/output terminal 33 of the present invention can also be used to connect with a mobile phone, for example, the input/output end of mobile phone is connected with the first external analog voice-input/output terminal 33 to render the bluetooth headset 21 to proceed with two-way vocal message transmission with the mobile phone through the telephone-controlling device for integrating bluetooth communication of the present invention, thereby the present invention can also be provided for transferring so as to receive the phone call from the mobile telephone.

The telephone-controlling device of the present invention includes further a telephone transfer switch 11a connecting with the microprocessor 11; after pressing the telephone transfer switch 11a, it renders the microprocessor 11 to proceed with transferring between the external telephone network 31 and the bluetooth headset 21. The telephone-controlling device of the present invention includes further a small night-light switch 11b connecting with the microprocessor 11, in order that it renders the microprocessor 11 to turn on a small night-light 11c, and thereby provides a minute amount of illumination.

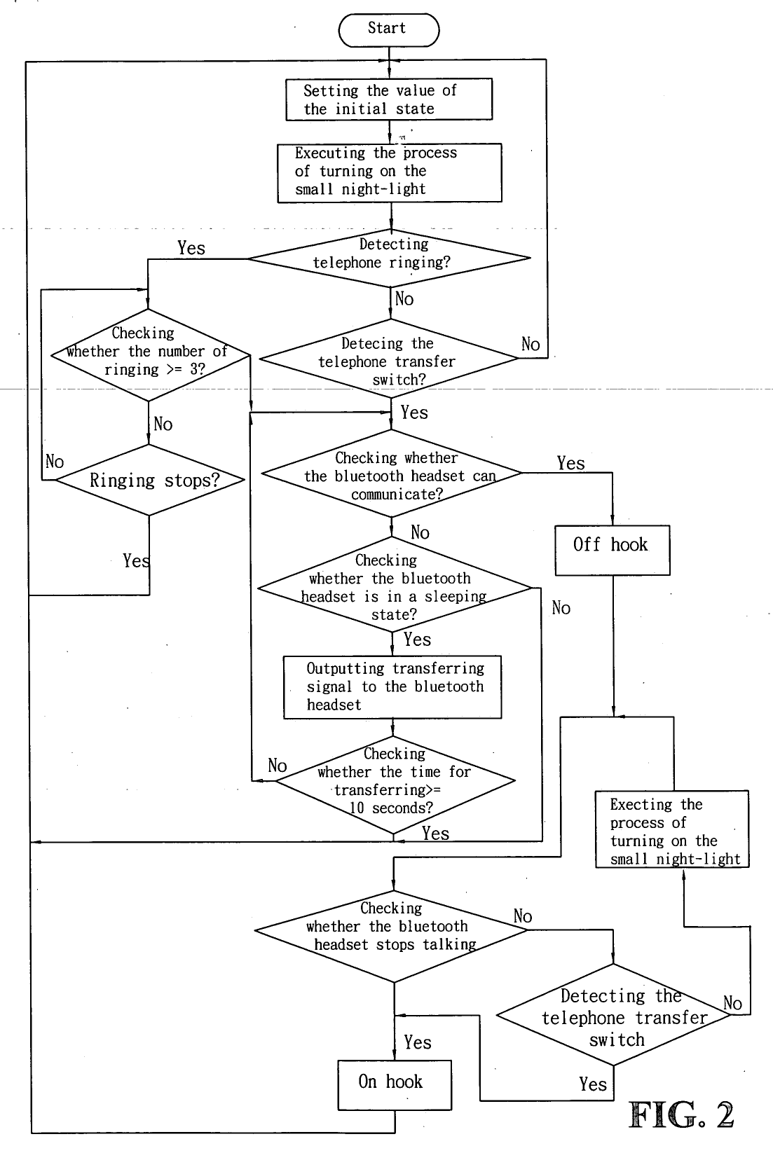

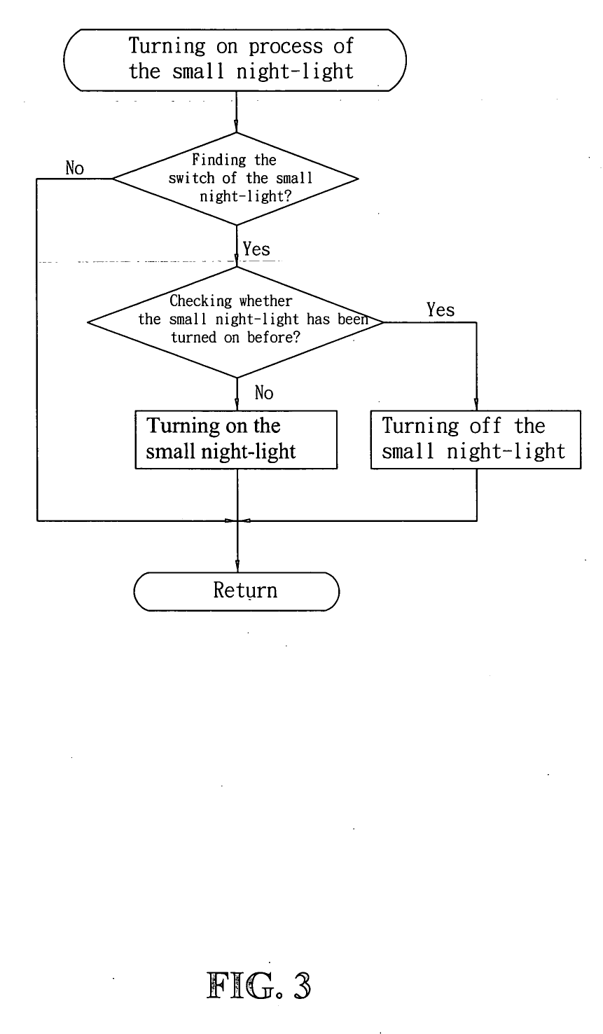

FIG. 2 is a control flowchart showing how the microprocessor controls the telephone interface circuit and the bluetooth interface circuit. FIG. 3 is a flowchart showing controlling of turning on of the small night-light 11c. With respect to the specific implementation mode about the flowcharts as shown in FIGS. 2 and 3, they may be implemented with firmware, and are executed by the microprocessor 11. When a phone call comes from the external network 31, for instance, when the number of ringing is larger than 3, then the microprocessor 11 checks whether the bluetooth headset 21 can proceed to conversation in order to render the external telephone network 31 to make two-way telephone conversation with the bluetooth headset 21. The present invention uses the number over 3 of ringing for illustrating, the number of ringing is not limitated to 3, and can be adjusted and set. When the telephone transfer switch 11a is pressed to produce signals, the microprocessor 11 checks whether the bluetooth headset 21 can proceed to conversation, if it can, for example, it renders the sound messages transmitted by the second external analog voice-input/output terminal 35 to proceed with two-way conversation with the bluetooth headset 21. If the bluetooth headset 21 checked is unable to proceed to conversation now, for example, the bluetooth headset 21 in the sleeping state for saving electricity and can't proceed to conversation, then transferring with the bluetooth headset 21 is tried once more; for instance, trying to transfer for 10 seconds, trying to see if there is a chance to make connection with the bluetooth headset 21 in 10 seconds. The present invention uses 10 seconds of transferring time for illustrating, it is not limited to 10 seconds; the time for trying to transfer can be adjusted and set. After the stage of executing transferring of the bluetooth headset 21, the microprocessor 11 will execute the process of turning on the small night-light 11c by the way for turning on/off the small night-light 11c depending on the signals produced by pressing the small night-light switch 11b.

The telephone-controlling device of the present invention includes further a recharge circuit 157; the major function of the recharge circuit 157 is to provide recharging electric power for the bluetooth headset 21 which uses a rechargeable battery as its electric power.

The telephone-controlling device of the present invention further is to upgrade the bluetooth headset 21 as a hands-free; a user can put on the bluetooth headset 21 very conveniently. Because the telephone-controlling device always monitors the status of the external telephone network 31, the user can move freely at a work place or at home, and answers a phone call at any time by carrying the present invention on his person; a conventional wireless telephone is unable to compete with the present invention in convenience indeed. The enhanced effect of the present invention is very much apparent.

Furthermore, The telephone-controlling device of the present invention further includes the first external analog voice-input/output terminal 33 which converts the vocal messages or other sound messages into vocal messages or other sound messages to be transmitted wirelessly to communicate with the bluetooth headset 21. The present invention can be used further as a contact and intercommunication tool for bluetooth communication.

It will be apparent to those skilled in this art that various equivalent modifications and changes can be made to the present device without departing from the spirit and concepts of this invention. Accordingly, all such modifications and changes and such equivalent concepts also fall within the scope of the appended claims.

What is claimed is:

1. A telephone-controlling device for integrating bluetooth communication comprising:
a microprocessor is used to control a telephone interface circuit and a bluetooth interface circuit, and to render said telephone interface circuit to proceed to connecting with an external telephone network, and to render said bluetooth interface circuit to proceed to connecting with a bluetooth headset;
said telephone interface circuit is connected with said microprocessor, and is used to connect with said external telephone network;
said bluetooth interface circuit is connected with said microprocessor, and is used to proceed with wireless two-way transmission of sound messages with said bluetooth headset;
thereby when in receiving a phone call by way of said external telephone network, said microprocessor performs controlling in order that said bluetooth headset communicates with said phone call directly.

2. The telephone-controlling device for integrating bluetooth communication as in claim 1, wherein said telephone interface circuit includes:
a rectifier connecting with a telephone line, wherein said telephone line is connected with said external telephone network;
a tone detector connecting with said rectifier and outputting ringing signals for said microprocessor to detect whether there are the ringing signals;
a hanging hook controller connecting with said microprocessor and being used to render said microprocessor to control on/off hook to thereby cut off or connect with said external telephone network;
a speech network circuit connected with said hanging hook controller, said rectifier, and a second external analog voice-input/output terminal separately for mutual receiving and transmitting vocal messages with said external telephone network.

3. The telephone-controlling device for integrating bluetooth communication as in claim 1, wherein said bluetooth interface circuit includes:
an antenna;
a bluetooth module connecting with said antenna, and connecting with said microprocessor to proceed with wireless two-way voice transmission with said bluetooth headset.

4. The telephone-controlling device for integrating bluetooth communication as in claim 3, wherein said bluetooth interface includes further an ADC/DAC (Analog-to-Digital Converter and Digital-to-Analog Converter) connecting with said bluetooth module, so as to convert sound messages transmitted between said bluetooth module and a first external analog voice-input/output terminal.

5. The telephone-controlling device for integrating bluetooth communication as in claim 4, wherein said first external analog voice-input/output terminal is electrically connected with said second external analog voice-input/output terminal.

6. The telephone-controlling device for integrating bluetooth communication as in claim 3, wherein said bluetooth interface circuit includes further a recharge circuit to provide recharging electric power for said bluetooth headset.

7. The telephone-controlling device for integrating bluetooth communication as in claim 1, said device further includes a telephone transfer switch connecting with said microprocessor to render said microprocessor to proceed to transferring with said bluetooth headset.

8. The telephone-controlling device for integrating bluetooth communication as in claim 1, said device further includes a small night-light switch connecting with said microprocessor to render said microprocessor to turn on a small night-light, wherein said small night-light provides a minute amount of illumination.
